(19) United States
(12) Patent Application Publication
(10) Pub. No.: US 2007/0077330 A1
(43) Pub. Date: Apr. 5, 2007

(54) Chinese Fortune Cookie Made of Chewing-Gum

(76) Inventor: Jonathan FACTOR, Tel-Aviv (IL)

Correspondence Address: BRUCE E. LILLING;LILLING & LILLING PLLC, P.O. BOX 560, GOLDEN BRIDGE, NY, 10526, US

(21) Appl. No.: 11/531,614

(22) Filed: Sep. 13, 2006

Related U.S. Application Data
(60) Provisional application No. 60/716,512, filed on Sep. 14, 2005.

(51) Int. Cl. A23G 4/00

(52) U.S. Cl. 426/3

(57) ABSTRACT

The present invention discloses a dough-free Chinese fortune cookie that comprises a paper note at least partially encapsulated within a chewing gum. The invention also discloses a method of manufacturing a dough-free Chinese fortune cookie, comprising the steps of obtaining a chewing gum and a paper note and at least partially encapsulating said note within a chewing gum.

### BACKGROUND OF THE INVENTION

1. Field of the Invention

The present invention relates to a dough-free Chinese fortune cookie comprising a paper note at least partially encapsulated within a chewing gum.

2. Summary of the Related Art

The fortune cookie is a dough-made cookie with a paper note inside with words of supposed wisdom and/or prophecy, commonly found at Chinese restaurants throughout the United States and elsewhere. After WWII, a number of Americanized Chinese restaurants copied the idea. Fortune cookies became very popular, served as a dessert after every meal at many if not most of the restaurants. In addition to a fortune, fortune cookies may also contain lucky numbers and a Chinese phrase with translation. The fortune cookie is usually not tasty, dry, and lacking in any notable organoleptic value. Moreover, the dough is fat, sweet and sticky, hence may cause dental and oral diseases. Although its attractiveness to toddlers and others, by being served at the end of the meal, the tasteless and emplastic Chinese fortune cookie is the worst desert one can get.

Chewing gums are widely considered today as a dietetic nutrichemicals, characterized by pH buffering abilities, sugar free sweeteners, teeth bleachers etc. Chewing gum itself does suggested in the art to contribute to plaque reduction, and some studies have shown beneficial effects on oral hygiene, calculus and/or gingivitis. In addition to this, there is an increasing body of evidence emerging that chewing of sugar-free gum like Wrigley's Orbit™ can remineralise the tooth surface and help prevent caries. Those tasteful food-like compositions are traditionally enveloped in a polymeric or metallic shell or dispensed as is.

### SUMMARY OF THE INVENTION

It is thus one object of the present invention to disclose a dough-free Chinese fortune cookie comprising a paper note at least partially encapsulated within a chewing gum.

It is a second object of the present invention to disclose a method of encapsulating a paper note within a chewing gum and to provide a cost-effective process for the production of dough-free Chinese fortune cookie comprising a paper note, at least partially encapsulated within a chewing gum.

### BRIEF DESCRIPTION OF THE SEVERAL VIEWS OF THE DRAWINGS

FIG. 1 is a schematic view of a traditionally designed dough-free Chinese fortune cookie comprising a paper note encapsulated within a chewing gum; wherein scheme A shows a topical view and scheme B shows an imaginary internal view of the same according to one preferred embodiment of the invention.

### DESCRIPTION OF THE PREFERRED EMBODIMENTS

The following specification taken in conjunction with the drawings sets forth the preferred embodiments of the present invention. The embodiments of the invention disclosed herein are the best modes contemplated by the inventors for carrying out their invention in a commercial environment, although it should be understood that various modifications can be accomplished within the parameters of the present invention.

The term ‘Chinese fortune cookie’ refers hereinafter to any food comprising a paper or paper-like note accommodated inside an edible shell, wherein said shell is at least partially characterized by either a continuous wing, a porosive net or any combination thereof.

The term ‘paper note’ refers hereinafter to any media comprising data or information, wherein the data is selected in a non-limiting manner from any data, written text, draws, pictures, cartoons, symbols, notes, musical notes, symbols, coded or indexed matter, numbers, video or musical trucks, valuables, money or money-worth articles, artistic matter or a combination thereof. The said data is written, coated, doped, impregnated, magnetized, injected, dissolved, immersed, immobilized, glued, weld, leached, bleached, reacted in any manner on or in a substrate or a plurality of substrates, hereinafter denoted in the term ‘paper’. Said paper is selected in a non limiting manner form any continuous or discontinuous matter, adapted to contain said data and display the same in either a remote manner (e.g., RFID means, Bluetooth etc) or a direct manner (e.g., ink on a paper). Said paper is either coated or enveloped by at least one suitable envelope, such as a polymeric or metallic sheet or placed ‘as is’ inside said chewing gum outer envelope.

The term ‘chewing gum’ related in the present invention to any type of confectionery which is designed to be chewed, not swallowed. The gum is preferably made of chicle, a natural latex product. The term also refers to a Nicotine gum which is designed especially for people who are trying to quit smoking and to other types of gum that are designed specifically for dental hygiene for whiten teeth, clean teeth, and freshen breath etc The term is also denoted for Bubblegum and other types of chewing gum that is especially designed for blowing bubbles. The chewing gum as defined in any of the above may comprise additives, selected in a non limiting manner for flavoring agents, smell inducing agents, texture agents, colorants, menthol or its like, plant extracts, fruits or vegetables and whole parts of milled particles thereof, sugars and other carbohydrates, artificial sweeteners, biocides, preservatives, elastomers, medicaments, vitamins, enzymes, nutrichemicals, pH buffers or any combination thereof. The term chewing gum refers also to any sheet, leaf, bar, or sheet-like member being adapted to encapsulated said note. The term sheet-like member may be either coated or not coated.

The term ‘nutrichemical’ refers hereinafter to “medical food”, “optimum food”, “phytochemical”, “phytomin”, “phytonutrient”, “therapeutic food” and to any food containing naturally occurring compounds that (a) are customarily considered neither nutrients nor toxins and (b) may contribute to preventing or curing disease.

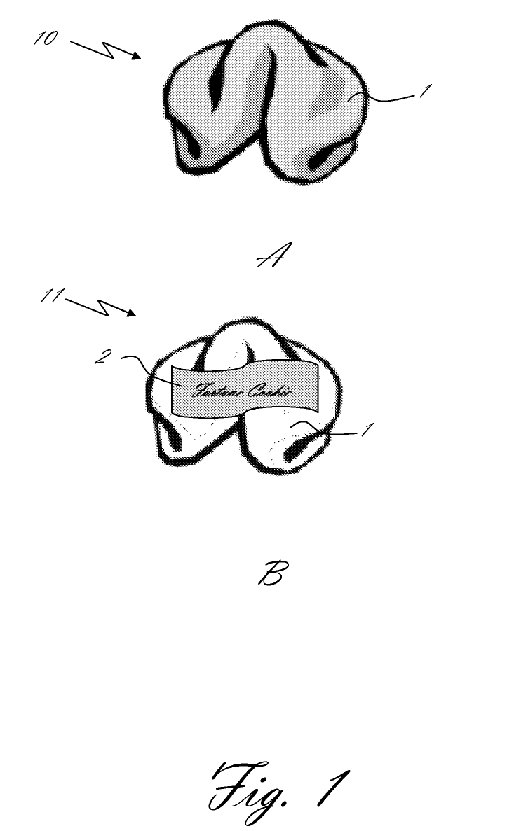

Reference is made now to FIG. 1, schematically presenting a dough-free Chinese fortune cookie (10) (outer view) according to one embodiment of the present invention, comprising a paper note (2) encapsulated within a chewing gum shell (1). An imaginary internal view of the same (11) is also provided, whereat a paper note (2) is displayed. It is acknowledged in this respect that other designs other than the traditional format (10) are possible and commercially applicable.

It is thus one object of the present invention to disclose a dough-free Chinese fortune cookie comprising a paper note at least partially encapsulated within a chewing gum.

It is a second object of the present invention to disclose a method of encapsulating a paper note within a chewing gum and to provide a cost-effective process for the production of dough-free Chinese fortune cookie comprising a paper note, at least partially encapsulated within a chewing gum. More specifically, the present invention discloses a method of manufacturing a dough-free Chinese fortune cookie. The method comprises the steps of obtaining at least one chewing gum and at least one paper note and then at least partially encapsulating said note within a chewing gum.

1. A dough-free Chinese fortune cookie comprising a paper note at least partially encapsulated within a chewing gum.

2. A method of manufacturing a dough-free Chinese fortune cookie comprising obtaining a chewing gum and a paper note and at least partially encapsulating said note within a chewing gum.
